(19) United States
(12) Patent Application Publication
(10) Pub. No.: US 2014/0175240 A1
(43) Pub. Date: Jun. 26, 2014

(54) BRACKET FOR LOUVERED ROOF SYSTEMS

(71) Applicant: C. Scott Selzer, Cumming, GA (US)

(72) Inventor: C. Scott Selzer, Cumming, GA (US)

(21) Appl. No.: 14/081,774

(22) Filed: Nov. 15, 2013

Related U.S. Application Data
(60) Provisional application No. 61/726,610, filed on Nov. 15, 2012.

(51) Int. Cl. E04B 7/16; F16M 13/02

(52) U.S. Cl. CPC E04B 7/163; F16M 13/02
USPC 248/237; 49/82.1; 49/87.1

(57) ABSTRACT

A louvered roof includes a drive mechanism securely fastened to a pivot arm via a gear pin, a plurality of louver roof panels configured to rotate about a center axis via a corresponding plurality of pivotal pins, a track section, and a track bar securely mounted to each of the plurality of louver panels via a plurality of corresponding track pins of end brackets securely mounted to opposing ends of the plurality of louver panels and configured to rotate the plurality of louver panels about the center axis of their respective central pivotal pins via a rotation of the motor gear.

### RELATED APPLICATIONS

This application claims priority to U.S. Provisional Patent Application No. 61/726,610, filed on Nov. 15, 2012 and entitled, “Improved Bracket For Louvered Roof Systems”. The entire contents of which are herein incorporated by reference.

### FIELD OF THE INVENTION

This invention relates to the control and configuration of a louvered roof with a series of louvers controlled by a linear driver assembly, and more particularly to a novel panel/louver end bracket for such systems.

### BACKGROUND OF THE INVENTION

Conventionally, louvered roof assemblies generally include a plurality of parallel louvers which are pivotally supported on a frame above a patio or portion of a home. The louvered roof assemblies are adjustable and may be opened or closed from a motor operated by a battery and/or person.

There are numerous deficiencies with louvered roof assemblies that exist today. For example, the louvered roof panels are not configured to close directly onto one another. Another shortcoming is the designs of the motors and actuators which move to open and close the panels. Conventional designs fail to offer reasonable maintenance options leaving the owner of such assemblies without a reasonable remedy to correct problems which arise unexpectedly. Another known deficiency is the overlapping surface area of the motor assembly being located within the water flow area of a corresponding assembly gutter. Such a configuration may result in water damage to the motor and a short to any corresponding electrical connectors.

### SUMMARY OF THE INVENTION

Example embodiments provide a water resistant and optimized louvered roof system that opens and closes securely and efficiently. The drive system, including motorized and manual types, ensures durability and long-lasting success to the owner of such a roof system.

In one embodiment, a roof system comprising a drive mechanism securely fastened to a pivot arm via a gear pin, a plurality of end brackets mounted to opposing ends of a plurality of louver roof panels, the panels configured to rotate about a center axis via a corresponding plurality of pivot pins, a track section, and a track bar securely mounted to each of the plurality of louver panels via a plurality of corresponding central pins securely fitted to one end of a plurality of louver panels and configured to rotate the plurality of louver panels about the center axis of their respective pivotal pins via a rotation of the drive mechanism.

The louver panel comprises a central aperture formed in the panel and receiving the pivot pin, elongated rails depending from the central aperture formed in the panel, flanges upwardly depending from the rails, and a ledge formed on the inside of one of the flanges.

In one embodiment, the drive mechanism comprises an actuator coupled to an actuator mounted coupled to a support member, an output shaft depending from the actuator. The system further comprises an actuator housing protecting the drive mechanism. The system may also comprise a motor operatively coupled to the actuator for urging movement of the drive mechanism.

In another embodiment, the drive mechanism comprises a gear box operatively coupled with a small diameter toothed-gear via a through-bolt, a large diameter toothed-gear operatively coupled with the small diameter toothed-gear, and an arm depending from the large diameter toothed-gear and operatively coupled with the track bar. The drive mechanism may further comprise a bolt extending from the gear box, an aperture formed at the end of the bolt, and an elongated pole with a hooked-end for communicating with the aperture of the bolt extending from the gear box.

In another embodiment, the drive mechanism comprises a louver end bracket coupled to the track bar, a chain guard inserted over a sprocket, an assembly bracket mounted to a support, the assembly bracket receiving the sprocket, chain guard, and louver end bracket, the sprocket operatively coupled with a small diameter toothed-gear. The drive mechanism may further comprise a gear box operatively coupled with the small diameter toothed-gear via a through-bolt, a large diameter toothed-gear operatively coupled with the small diameter toothed-gear, and an arm depending from the large diameter toothed-gear and operatively coupled with the track bar.

The louvered end bracket comprises a face, and a central bracket post and two distal bracket posts equidistant from the central bracket post. The chain guard may comprise a sprocket channel formed by a half-radius, an edge opposite the half-radius, the edge having an alignment aperture and a mounting aperture, the edge configured to provide articulation to the chain guard upon movement of the sprocket.

The sprocket may comprise an outer radius forming a plurality of teeth engaging with the teeth of the small diameter toothed-gear, a semi-circular slit concentric to the outer radius, a plurality of circular apertures concentric to the slit, a center aperture, and a pair of sprocket posts equidistant from the center aperture.

The assembly bracket may comprise a support, a mounting post depending from the support, and a mounting nipple depending from the support.

In one embodiment, the panel system may include an end bracket for mounting to opposed ends of a panel or louver of a louvered roof system, the end bracket comprising an elongated body, the body comprising a base from which an integral sidewall extends vertically therefrom. The body is dimensioned so as to sizably accommodate the width and thickness of selected panels or louvers in a snug, fitting manner. The end bracket further comprises a first pivot pin projecting perpendicularly from a lower surface of the base. The end bracket may further comprise a second pivot pin projecting perpendicularly from a lower surface of the base.

### BRIEF DESCRIPTION OF THE DRAWINGS

FIG. 1 illustrates a louvered roof assembly, according to example embodiments;

FIG. 2A illustrates an exterior top view of the louvered roof assembly in a closed position, according to example embodiments;

FIG. 2B illustrates an exterior top view of a louvered roof assembly in a partially closed position, according to example embodiments;

FIG. 2C illustrates an exterior top view of a louvered roof assembly in an open position, according to example embodiments;

FIG. 3A illustrates an interior view of a louvered roof assembly in an open position, according to example embodiments;

FIG. 3B illustrates an interior view of a louvered roof assembly in a partially opened position, according to example embodiments;

FIG. 3C illustrates an interior view of a louvered roof assembly in a closed position, according to example embodiments;

FIG. 4 illustrates a side view of an individual louvered panel coupled to a support member, according to example embodiments;

FIG. 5 illustrates a front view of an individual louvered panel coupled to a support member, according to example embodiments;

FIG. 6 illustrates a side view of a linear drive assembly, according to example embodiments;

FIG. 7 illustrates a perspective view of a housing, according to example embodiments;

FIG. 8A illustrates a perspective view of an actuator mount, according to example embodiments;

FIG. 8B illustrates a perspective view of a bushing, according to example embodiments;

FIG. 9A illustrates a front perspective view of an arm, according to example embodiments;

FIG. 9B illustrates a rear perspective view of an arm, according to example embodiments;

FIG. 10 illustrates a perspective view of a case, according to example embodiments;

FIG. 11 illustrates a front view of an individual louvered panel coupled to a support member and the arm coupled to the support member and track bar, according to example embodiments;

FIG. 12 illustrates a perspective view of a manual drive mechanism, according to example embodiments;

FIG. 13 illustrates a side view of the manual drive mechanism including a driven arm, according to example embodiments;

FIGS. 14A-14D illustrate an alternate embodiment of a manual drive mechanism;

FIG. 14E is a perspective view of a spacer for connecting supports, in accordance to one embodiment of the present invention;

FIG. 15 illustrates a louver end bracket of the drive mechanism depicted in FIGS. 14A-14D;

FIGS. 16A-16B illustrate a guard mechanism of the drive mechanism depicted in FIGS. 14A-14D;

FIG. 17 illustrates a sprocket of the drive mechanism depicted in FIGS. 14A-14D; and

FIG. 18 illustrates an assembly bracket of the drive mechanism depicted in FIGS. 14A-14D.

### DESCRIPTION OF THE EMBODIMENT(S)

It will be readily understood that the components of the present invention, as generally described and illustrated in the figures herein, may be arranged and designed in a wide variety of different configurations. Thus, the following detailed description of the embodiments as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

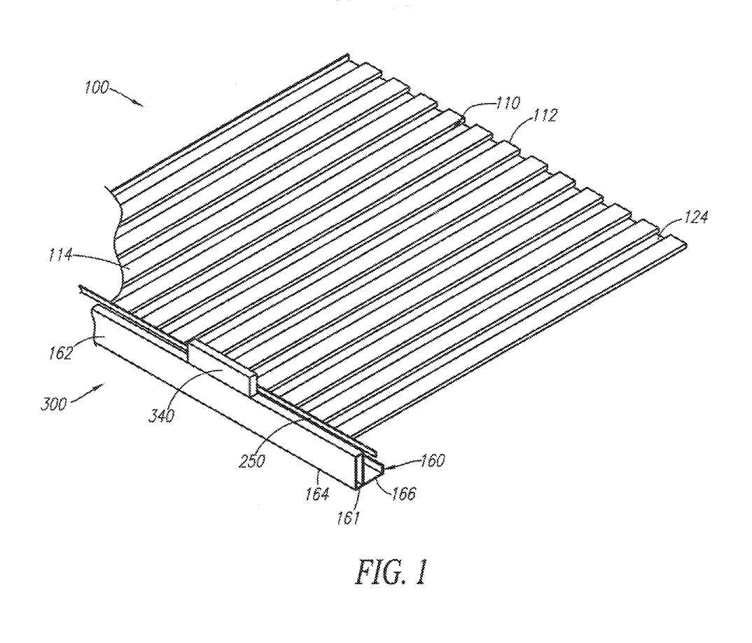

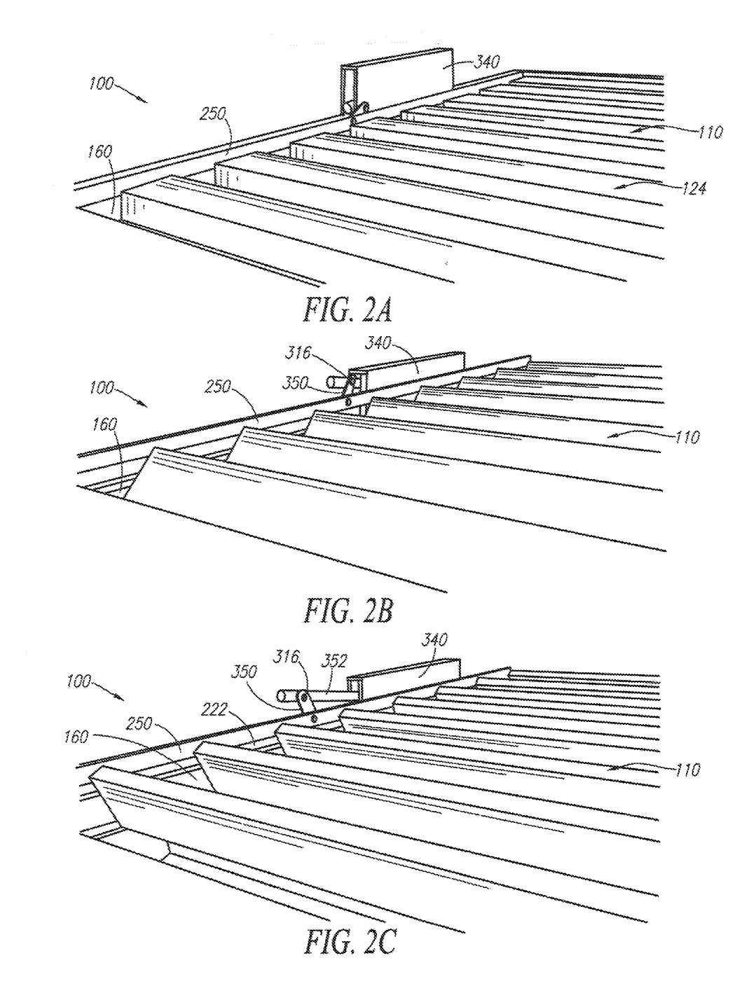

FIG. 1 illustrates a louvered roof 100, according to example embodiments. FIG. 1 and FIG. 2A illustrate partial perspective views of the louver roof panels 110 of louvered roof 100 engaged in a closed position. Such a position would protect an underlying area from rain or sunlight. The louver roof panels 110 engage one another via their respective overlapping flanges or lips and form channels 124 through which rain may flow through to reach the gutters 166 perpendicular to the louver panels and located below each of the opposing panel ends 112, 114. An actuator or motor housing 340 protects the actuator and linear drive system 300 from outdoor conditions. The motor assembly includes a linear drive system. A connecting rod or track bar 250 provides a secure fixture to engage each of the louver panels so that they may be opened and closed by an actuating movement of the track bar 250.

The louvered roof panels 110 are supported for rotational movement by a pair of elongated support members 160 that are arranged perpendicular to the length of panels 110. One support member 160 supports panel ends 112 and another support member 160 supports panel ends 114. Support members 160 have opposite ends 161 and 162. Support members 160 are formed by the combination of a rectangular shaped beam 164 and an attached gutter 166. As best viewed in FIG. 5, beam 164 includes an outer side 168, inner side 170, top side 172 and bottom side 174. Gutter 166 has an internal trough 167 to carry rainwater and is attached to inner side 170 by screws 165. Support members 160 and roof panels 110 can be formed from suitable materials such as aluminum.

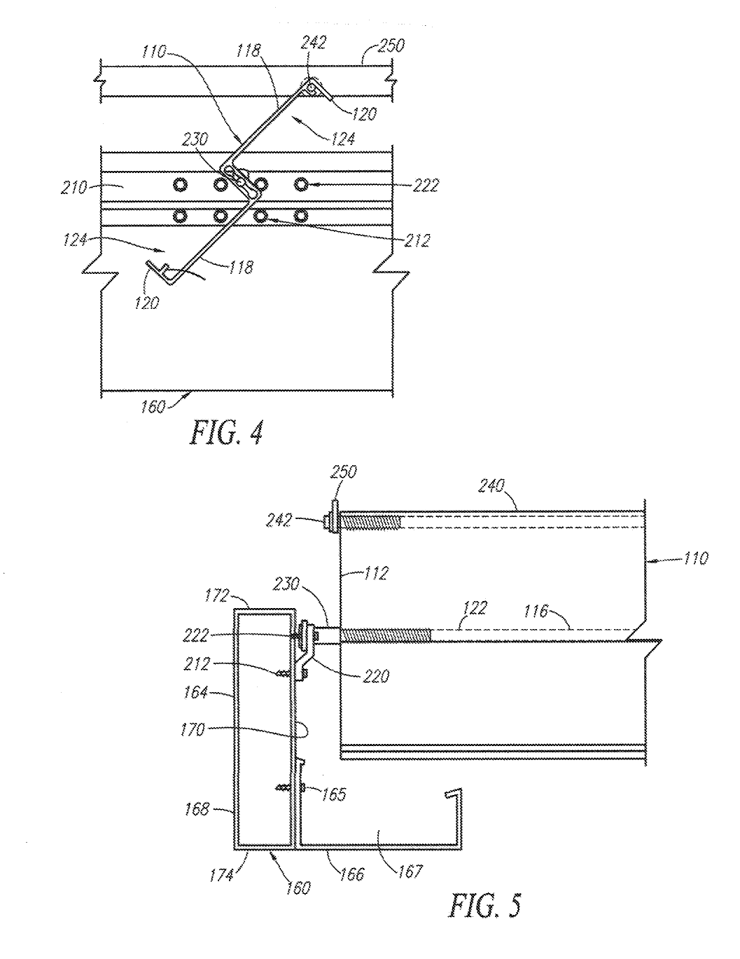

Referring to FIGS. 4 and 5, details of the connection of roof panels 110 to support members 160 are shown. An elongated pivot strip 210 is attached to the inner side 170 of beam 164 by screws 212. An angled lock bar 220 is attached to the pivot strip 210 by screws 222. One lock bar 220 is located at each corresponding end of each panel 110. A pivot pin 230 extends through an aperture in the lock bar 220 and has an end that is received by bore 122. Roof panel 110 rotates or pivots about an axis defined by the length of pivot pin 230. A pivot pin 230 is centered about the width of each of the roof panels 110.

Another bore 240 extends perpendicularly into roof panel end 112 at the junction of rail 118 and flange 120. A track pin 242 extends through an aperture in a track bar 250 and has an end that is received by bore 240. Track bar 250 rotates or pivots about an axis defined by the length of track pin 242. Each of the roof panels 110 is attached to the track bar 250 by a track pin 242.

Each roof panel 110 comprises a central aperture through which the pivot pin 230 is received. Depending from the portion forming the aperture are elongated rails 118 and flanges 120 upwardly depending from the junction of the rails 118 and flanges 120. A ledge 121 is formed on the inside of a flange 120. The ledge 121 depends from the inside perimeter of the flange 120 and forms a platform that engages the terminal end of flange 120 when adjacent roof panels 110 are placed into the closed position. The engagement of the ledge 121 and the terminal end of the flange 120 prevents over-rotation of the panels 110, and thereby averting damage, while also preventing water from wicking between the panels 110 and onto the area protected below the louver system.

FIG. 2A illustrates an exterior view 210 of a louvered roof system in a closed position, according to example embodiments. Referring to FIG. 2A, the track bar 222 runs parallel to the louver roof panels and engages each of the louver panels to provide a secure mounting fixture that connects the track bar 222 with each of the louver panels on one side. As the motor is operated and the motor bar 220 begins to shift its present position, each of the louver panels will begin to move in unison with one another to open or close according to the present position of the louver panels.

FIG. 2B illustrates an exterior view of a louvered roof system 220 in a partially closed position, according to example embodiments. In this illustration, the louver panels have been partially opened and the motor bar 220 has begun to shift outside the housing 212 which causes the louver panels to begin turning in unison. FIG. 2C illustrates an exterior view 230 of a louvered roof system in an open position, according to example embodiments. Referring to FIG. 2C, the panels are in a full and upright position allowing maximum light to pass through the area between the louver panels. The motor bar 220 is in a fully elongated position as it has been shifted completely outside of the protective housing.

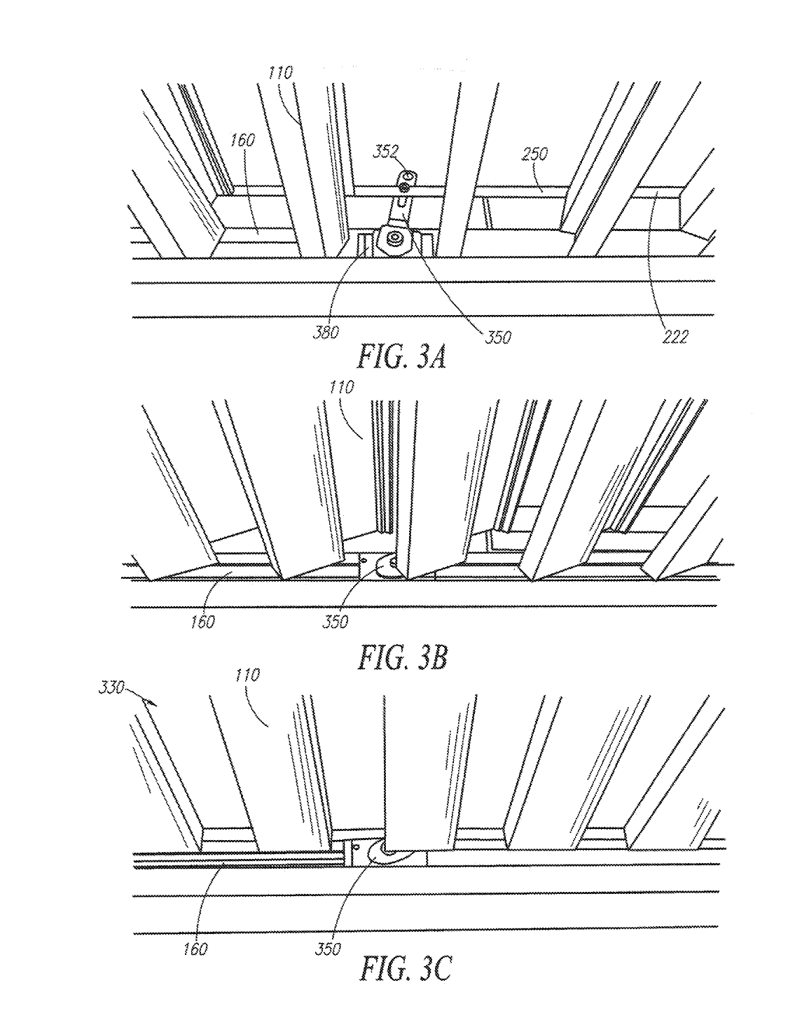

FIG. 3A illustrates an interior view 310 of a louvered roof system in an open position, according to example embodiments. Referring to FIG. 3A, the track bar 222 and the motor gear 312 move together to open each of the louver roof panels in unison.

FIG. 3B illustrates an interior view 320 of a louvered roof system in a partially opened position, according to example embodiments. Referring to FIG. 3B, the louver roof panels are partially closed. In FIG. 3C, the roof panels are in a fully closed position 330, according to example embodiments.

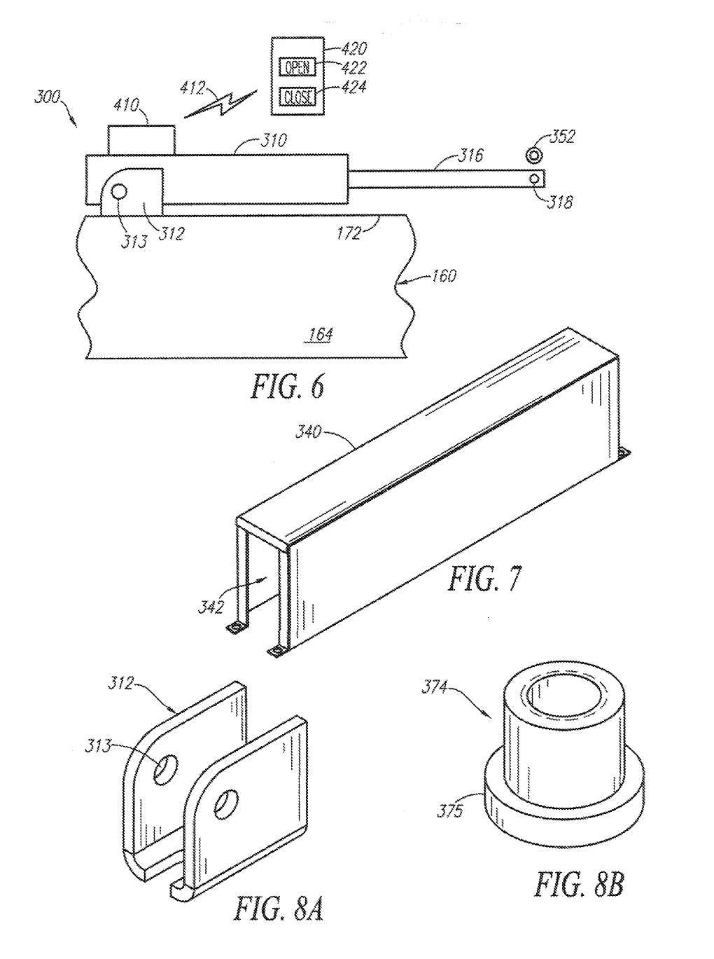

In reference to FIG. 6, louvered roof assembly 100 further includes a control system 400. Control system 400 can cause linear actuator 310 to open and close roof panels 110. Control system 400 includes a controller 410 and a user input device 420. Controller 410 includes an electronic circuit to drive linear actuator 310 and a transceiver that can receive and send signals such as wired or wireless signals 412. Signals 412 can be RF, IR or wired signals. In one embodiment, user input device 420 is a remote control unit that can send and receive signals such as wireless signals 412 to and from controller 410. User input device 420 has an open button 422 that causes linear actuator 310 to open roof panels 110 and a close button 424 that causes linear actuator 310 to close roof panels 110.

As also depicted in FIG. 6, a linear drive mechanism 300 is shown. Linear drive mechanism 300 comprises a linear actuator 310, an actuator mount 312 and an output shaft 316. Actuator mount 312 (FIG. 8A) is mounted to the top side 172 of beam 164 by screws. A linear actuator 310 is attached to actuator mount 312 by a bolt 313 (more closely detailed in FIG. 8A). Linear actuator 310 can rotate about bolt 313. Linear actuator 310 is connected to a power source such as a battery or utility power.

FIG. 7 illustrates an example of an actuator housing 340, according to example embodiments. The actuator housing protects the motor bar assembly from the outdoor environment and may be easily removed for maintenance. The housing 340 has an internal cavity 342. Housing 340 is mounted over linear actuator 310 to protect the actuator and linear drive system from outdoor conditions. Housing 340 is mounted to the top side 172 of beam 164 by screws. Housing 340 protects the linear drive mechanism 300 from the outdoor environment and may be easily removed for maintenance.

Linear actuator 310 has an output shaft 316. Linear actuator 310 can move output shaft 314 in a linear reciprocating manner along an axis generally parallel to the length of support member 160.

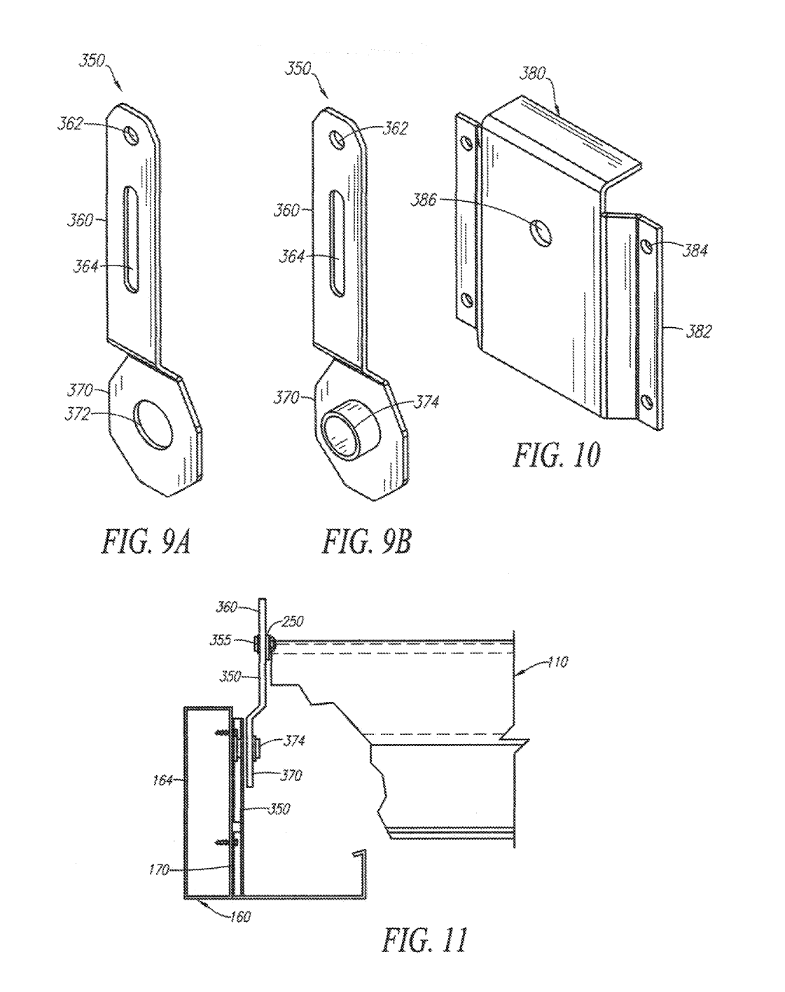

Output shaft 316 has a distal end with a thru bore 318. Connecting bolt and bushing 352 extends through an end of arm 350 and through bore 318. Connecting bolt and bushing 352 couples arm 350 to output shaft 316, while allowing rotation between arm 350 and output shaft 316. With additional reference to FIGS. 9A and 9B, arm 350 has an upper rectangular shaped section 360 and a lower hexagonal shaped section 370. Upper section 360 has a hole 362 and an elongated slot 364. Lower section 370 has an aperture 372 that is dimensioned to receive another bushing 374. Bushing 352 is received by hole 362 and is retained to upper section 360.

FIG. 8A illustrates an example of an actuator mount 312, according to example embodiments. Referring to FIG. 8A, the actuator mount may be securely mounted to the actuating assembly. FIG. 8B illustrates an example of a gear pin 374, according to example embodiments. The gear pin may be securely mounted to the gear pin portion of the assembly.

Referring to FIGS. 8B, 10 and 11, case 380 is mounted to the inner side 170 of beam 166. Case 380 has flanges 382 with apertures 384. Screws extend through apertures 384 are fixed to side 170. Case 380 further has a bushing hole 386. Bushing 374 extends through arm hole 372 and is press fit into bushing hole 386. Bushing head 375 rests against one side of lower section 370. In this manner, arm 350 can rotate about bushing 374. A drive coupling 355 such as a bolt and nut couples the track bar 250 to the arm 350. Drive coupling 355 extends through slot 364 and through a hole in track bar 250. Track bar 250 and arm 350 rotate about drive coupling 355. During operation, drive coupling 355 can slide along the length of slot 364.

The panels 110 are constructed of a rigid material, such as wood. Wood materials selected for panels 110 construction may be selected from the group comprising cedar, redwood, and exotic hardwood. Alternatively, panels 110 may be constructed of a rigid material selected from the group comprising plastic, thermoplastic, metal or a metallic-plastic composite. Preferred plastic or thermoplastic materials include polyvinyl chloride (PVC), polypropylene, polyolefin, acrylonitrile-butadiene-styrene (ABS), polyethylene, polyurethane, polycarbonate, or blends thereof, and ABS/Nylon blend. In the event plastic is the selected fabrication material, the panels 110 may fabricated utilizing a common molding process such as injection molding, blow molding, extrusion, or other molding and fabricating methods.

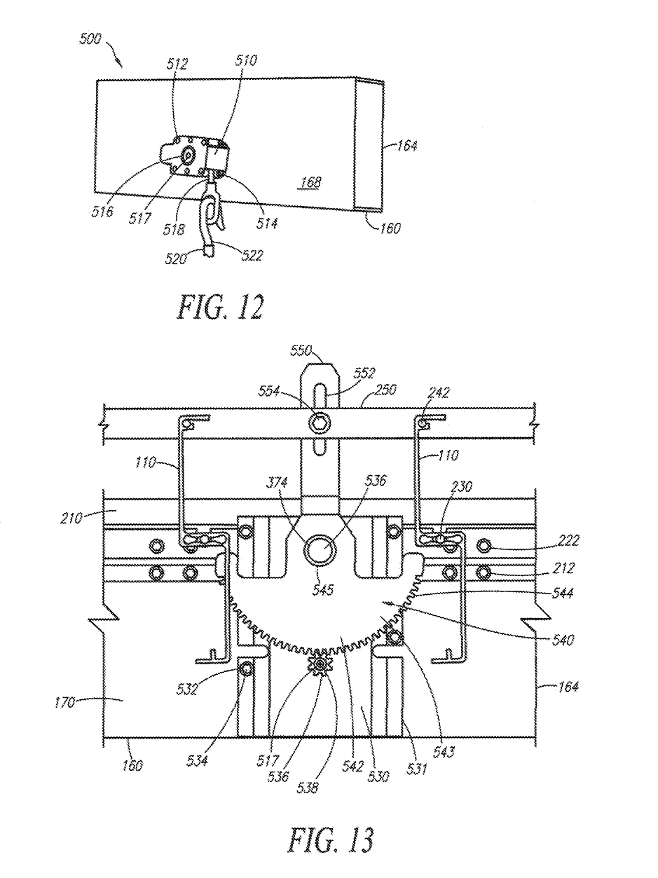

According to another example embodiment the motor assembly may include a manual crank drive system, as illustrated in FIGS. 12 and 13. Referring to FIG. 12, the motor assembly 500 includes a motor gear that may be connected to a manual crank drive system operated by manually by a user. FIG. 13 illustrates additional details of a manually operated motor configuration. The manual hand crank includes a moving gear that rotates based on a turning motion performed by a bolt 518. The user may use an elongated pole with a hooked end 522 to turn the bolt and create movement in the moving gear, which in turn changes the louver panel positions.

In accordance with FIGS. 12 and 13, another example embodiment louvered roof assembly 100 can include a manual drive mechanism 500. Manual drive mechanism 500 replaces the linear drive mechanism 300 previously described. Referring to FIGS. 12 and 13, manual drive mechanism 500 includes a ninety degree gear box 510 that is mounted to the outer side 168 of beam 164 by threaded bolts 512. Gear box 510 has a housing 514 that contains internal gears 516 and a through shaft 517.

A bolt 518 is connected to the internal gears 516 of gear box 510. Bolt 518 extends outwardly from housing 514. The manual drive mechanism 500 includes an elongated pole 520 with a hooked end 522 that engages the bolt 518. A user can rotate pole 520 to turn the bolt 518 thereby causing through shaft 517 to rotate via the internal gears 516 of gear box 510.

FIG. 13 illustrates details of a manually driven arm 540 used in manual drive mechanism 500. Referring to FIG. 13, case 530 is mounted to the inner side 170 of beam 166. Case 530 has flanges 531 with apertures 532. Screws 534 extend through apertures 532 and are fixed to side 170. Case 530 further has a bushing hole 536. Bushing 374 extends through arm hole 545 and is press fit into bushing hole 536. Arm 540 can rotate about bushing 374.

Driving arm 350 has an upper rectangular shaped end section 550 and a lower semi-circular shaped section 542. Upper section 550 has an elongated slot 552. Lower section 370 has teeth 544 formed on the outer circumferential edge of semi-circular shaped gear 543. A drive coupling 554 such as a bolt and nut couples the track bar 250 to the manually driving arm 540.

Drive coupling 554 extends through slot 552 and through a hole in track bar 250. Track bar 250 and arm 540 can pivot about drive coupling 554. During operation, drive coupling 554 can also slide along the length of slot 552. Roof panels 110 rotate or pivot about an axis defined by the length of pivot pin 230. A pivot pin 230 is centered about the width of each of the roof panels 110.

The distal end of shaft 517 faces into gutter trough 167 and has an attached gear 536 with teeth 538. Gear 538 has a much smaller diameter than gear 543 such that many turns of gear 538 are required to move gear 543 a small amount thereby providing force multiplication.

An operator can elect to manually open or close roof panels 110 using manual drive mechanism 500. In order to open or close roof panels 110, the operator rotates pole 520, turning the bolt 518 thereby causing rotation of through shaft 517 via the internal gears 516 of gear box 510. The rotation of through shaft 517 rotates gear 517, which in turn rotates gear 543 causing arm end 550 to move track bar 250 along an axis generally parallel to support members 160. The movement of arm end 550 causes the track bar 250 to move via the connection of coupling 355. The movement of track bar 250, which is connected to roof panels 110 via track pins 242, causes the louver panels 110 to rotate in unison about pivot pins 230 and move towards either an open or closed position depending upon the rotational direction of bolt 518.

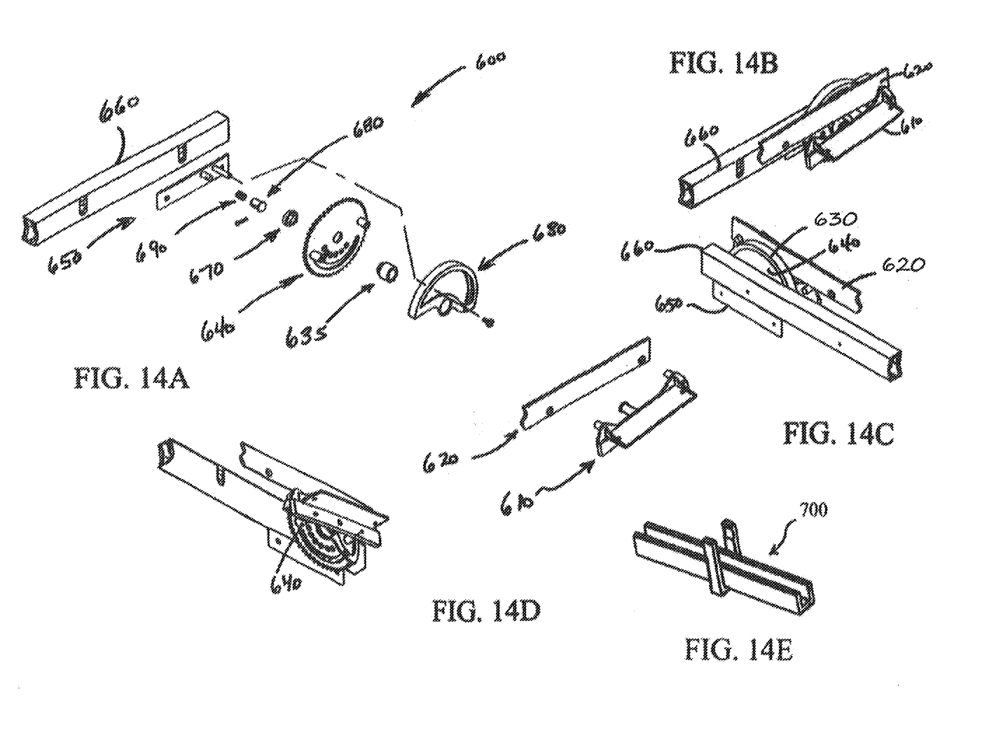

FIGS. 14A-14C depicts an alternative embodiment of the manual drive mechanism assembly denoted here by reference character 600. The assembly 600 includes a louver end bracket 610 coupled to one end of the track bar 620. A chain guard 630 partially encloses sprocket 640, the guard 630 and sprocket 640 properly positioned by a sprocket spacer 635. The sprocket 640 may be coupled to an assembly bracket 650. The sprocket 640 and assembly bracket 650 are properly positioned by a spacer 670, a snap fitting 680, and a fitting spring 690. The assembly bracket 650 may be supported by support 660. A spacer 700 (shown in FIG. 14E) is provided for detachably-connecting supports 660 in a secured manner, thereby providing for any selectively-desired lengths of supports 660 as selectively desired and/or required by user. The spacer 700 functions to interconnect supports 660 at opposed ends of the spacer 700.

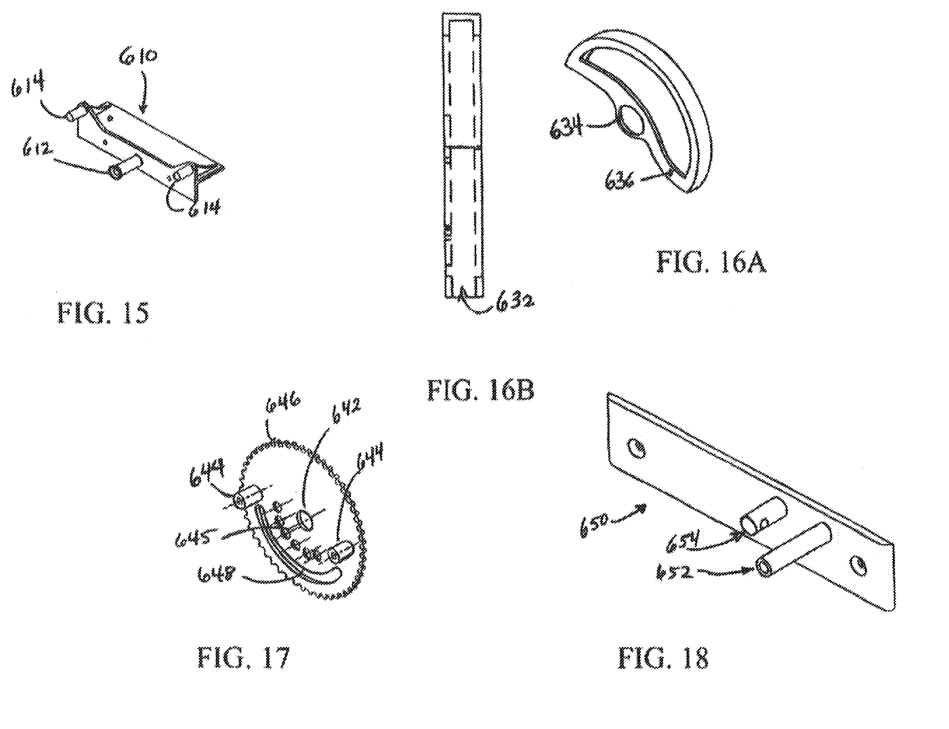

FIG. 15 depicts a louver end bracket 610 having a face from which a central bracket post 612 and two distal bracket posts 614 approximately equidistant from the central bracket post 612. The bracket posts 612 and 614 are positioned for alignment with the center aperture 642 and sprocket posts 644 formed on the sprocket 640.

FIGS. 16A-16B depicts a chain guard 630 having a sprocket channel 632 formed by and within an approximate half-radius R continuous along the perimeter of the chain guard 630. The chain guard 630 is formed to cover approximately half (or 180 degrees) of the sprocket 640 and therefore has the profile of a semi-circle. Along the edge opposing the radius, an alignment aperture 634 is formed near the center to receive the central bracket post 612 and aligning with the center aperture 642 provided on the sprocket 640. Adjacent the alignment aperture 634 is a mounting aperture 636 that corresponds to a mounting post 652 formed on the assembly bracket 650. The mounting aperture 636 and the mounting post 652 are joined by a threaded fastener, such as a screw or bolt. As will be seen in further detail, the mounting post 652 communicates with sprocket 640 via a slit 648 provided in the sprocket 640 surface. By arranging the chain guard 630 to be coupled with the assembly bracket 650 (by fastener) and intermediately disposed between the louver end bracket 610 and the assembly bracket 650, the chain guard 630 is free to articulate about the fastener and/or the central bracket post 612 in response to articulation by the sprocket 640 in opening and/or closing the louver panels 110. A large sprocket spacer 635 is arranged between the chain guard 630 and sprocket 640 (and best seen in FIG. 14A).

FIG. 17 depicts a sprocket 640 having a center aperture 642 and sprocket posts 644 formed equidistant from the center aperture 642. The outer radius of the sprocket includes a plurality of teeth 646 that engages with the distal end of shaft 517 that has the attached gear 536 and teeth 538. As previously noted, gear 538 has a much smaller diameter than sprocket 640 such that many turns of gear 538 are required to move sprocket 640 a small amount thereby providing force multiplication.

The sprocket 640 includes a semi-circular slit 648 that is concentric to the outer radius of the sprocket. The slit 648 receives the mounting post 652 of the assembly bracket 650 once coupled to the mounting aperture 636 of guard chain 630, and allows the sprocket 640 to articulate in a concentric motion about the mounting post 652.

The sprocket 640 also includes a plurality of circular apertures 645 defined through the surface of the sprocket 640 generally concentric relative to the slit 648 and offset relative to the aperture 642 and slit 648. The plurality of circular apertures 645 are spaced in a semi-circular orientation corresponding to and consistent with the shape defining the slit 648. The plurality of circular apertures 645 allow for the louver panels 110 to be selectively-adjustable, in unison, about a desired pivotal orientation as the sprocket 640 articulates, particularly such as pivotally. A spring-biased pin of a pin assembly engages a selected aperture 645 of the plurality of circular apertures 645, thereby detachably securing the sprocket 640 and thus, louver panels 110 about a desired pivotal position.

FIG. 18 depicts an assembly bracket 650 having a support from which the mounting post 652 depends and from which the mounting nipple 654 depends. As best seen in FIG. 14A, the mounting nipple receives the fitting spring 690, the snap fitting 680, and the spacer 670. Spacer 670 provides appropriate space between the sprocket 640 and assembly bracket 650 and its elements, and large sprocket spacer 635 provides appropriate spacing between the sprocket 640 and the chain guard 630.

The present invention is intended to be made commercially available as a kit, wherein the kit may comprise a package for housing a plurality of end brackets, a linear drive system (automatic or manual), an elongated handle member 520, a plurality of track sections, a plurality of track bars 250, gutters 166, and an instruction manual. The kit may further comprise various fasteners, push nuts, screws, coupling means, connectors, and the like.

An alternative kit may comprise components in addition to the above-described kit elements. Such components are envisioned to include, but are not limited to system support members 160, and panels or louvers 110.

Finally, a method for assembling and installing a louvered roof system is disclosed, wherein the method comprises the steps of: measuring the inside dimensions of a roof frame; determining a proper a louver board 110 length by subtracting approximately 3.25 inches from the inside dimensional measure; cutting the louver boards 110a in accordance to the determined louver board 110 length; mounting an end bracket to opposed ends of each louver board 110 via a securing means, such as stainless painted head screws; determining proper length of each track section; cutting a length from one end of each track section; mounting the track sections co-planar to the upper surfaces of system support members, respectively; installing the louver boards 110 in a spatially-aligned series to the track sections; securing the track bars 250 to the end brackets via a fastening means, such as stainless steel push nuts engaging the second pivot pins; installing a linear drive actuator, such as the manually-operated drive mechanism; and installing and securing a lock bar atop each track section.

It is to be understood that the embodiments and claims are not limited in application to the details of construction and arrangement of the components set forth in the description and/or illustrated in drawings. Rather, the description and/or the drawings provide examples of the embodiments envisioned, but the claims are not limited to any particular embodiment or a preferred embodiment disclosed and/or identified in the specification. Any drawing figures that may be provided are for illustrative purposes only, and merely provide practical examples of the invention disclosed herein. Therefore, any drawing figures provided should not be viewed as restricting the scope of the claims to what is depicted.

The embodiments and claims disclosed herein are further capable of other embodiments and of being practiced and carried out in various ways, including various combinations and sub-combinations of the features described above but that may not have been explicitly disclosed in specific combinations and sub-combinations.

Accordingly, those skilled in the art will appreciate that the conception upon which the embodiments and claims are based may be readily utilized as a basis for the design of other structures, methods, and systems. In addition, it is to be understood that the phraseology and terminology employed herein are for the purposes of description and should not be regarded as limiting the claims.

What is claimed is:

1. A kit for a louvered roof system, the kit comprising:
a plurality of end brackets;
a linear drive system;
an elongated handle member;
a plurality of track sections;
a plurality of track bars;
a plurality of lock bars;
an instruction manual; and
a package for housing the plurality of end brackets, the linear drive system, the elongated handle member, the plurality of track sections, the plurality of track bars, the plurality of lock bars, and the instruction manual.

2. A roof system comprising:
a drive mechanism securely fastened to a pivot arm via a gear pin;
a plurality of end brackets mounted to opposing ends of a plurality of louver roof panels, the panels configured to rotate about a center axis via a corresponding plurality of pivot pins;
a track section; and
a track bar securely mounted to each of the plurality of louver panels via a plurality of corresponding central pins securely fitted to one end of a plurality of louver panels and configured to rotate the plurality of louver panels about the center axis of their respective pivotal pins via a rotation of the drive mechanism.

3. The system of claim 2, wherein each louver panel comprises:
a central aperture formed in the panel and receiving the pivot pin;
elongated rails depending from the central aperture formed in the panel;
flanges upwardly depending from the rails; and
a ledge formed on the inside of one of the flanges.

4. The system of claim 2, wherein the drive mechanism comprises:
an actuator coupled to an actuator mounted coupled to a support member;
an output shaft depending from the actuator.

5. The system of claim 4 further comprising an actuator housing protecting the drive mechanism.

6. The system of claim 5 further comprising a motor operatively coupled to the actuator for urging movement of the drive mechanism.

7. The system of claim 2, wherein the drive mechanism comprises:
a gear box operatively coupled with a small diameter toothed-gear via a through-bolt;
a large diameter toothed-gear operatively coupled with the small diameter toothed-gear; and
an arm depending from the large diameter toothed-gear and operatively coupled with the track bar.

8. The system of claim 7 further comprises:
a bolt extending from the gear box;
an aperture formed at the end of the bolt; and
an elongated pole with a hooked-end for communicating with the aperture of the bolt extending from the gear box.

9. The system of claim 2, wherein the drive mechanism comprises:
a louver end bracket coupled to the track bar;
a chain guard inserted over a sprocket; and
an assembly bracket mounted to a support, the assembly bracket receiving the sprocket, the chain guard, and the louver end bracket;
the sprocket operatively coupled with a small diameter toothed-gear.

10. The system of claim 9 further comprising:
a gear box operatively coupled with the small diameter toothed-gear via a through-bolt;
a large diameter toothed-gear operatively coupled with the small diameter toothed-gear; and
an arm depending from the large diameter toothed-gear and operatively coupled with the track bar.

11. The system of claim 9, wherein the louvered end bracket comprises:
a face; and
a central bracket post and two distal bracket posts equidistant from the central bracket post.

12. The system of claim 9, wherein the chain guard comprises:
a sprocket channel formed by a half-radius;
an edge opposite the half-radius, the edge having an alignment aperture and a mounting aperture, the edge configured to provide articulation to the chain guard upon movement of the sprocket.

13. The system of claim 9, wherein the sprocket comprises:
an outer radius forming a plurality of teeth engaging with the teeth of the small diameter toothed-gear;
a semi-circular slit concentric to the outer radius;
a plurality of circular apertures concentric to the slit;
a center aperture; and
a pair of sprocket posts equidistant from the center aperture.

14. The system of claim 13, wherein the plurality of circular apertures are offset relative to the center aperture and slit.

15. The system of claim 9, wherein the assembly bracket comprises:
a support;
a mounting post depending from the support; and
a mounting nipple depending from the support.

16. The system of claim 15, wherein the mounting nipple receives a fitting spring, a snap fitting, and a spacer.

17. An end bracket for mounting to opposed ends of a panel or louver of a louvered roof system, the end bracket comprising:
an elongated body, the body comprising a base from which an integral sidewall extends vertically therefrom.

18. The end bracket of claim 17, wherein the body is dimensioned so as to sizably accommodate the width and thickness of selected panels or louvers in a snug, fitting manner.

19. The end bracket of claim 17, wherein the end bracket further comprises a first pivot pin projecting perpendicularly from a lower surface of the base.

20. The end bracket of claim 17, wherein the end bracket further comprises a second pivot pin projecting perpendicularly from a lower surface of the base.
